(19) United States
(12) Patent Application Publication
(10) Pub. No.: US 2018/0056490 A1
(43) Pub. Date: Mar. 1, 2018

(54) TOOLS AND METHODS FOR SETTING A PLUG INSIDE A PIPE

(71) Applicant: NUWAVE INDUSTRIES INC., Marwayne (CA)

(72) Inventors: Troy Illingworth, Dewberry (CA); Tim Sharp, Marwayne (CA); Dale Cusack, Vermillion (CA)

(73) Assignee: NUWAVE INDUSTRIES INC., Marwayne (CA)

(21) Appl. No.: 15/686,542

(22) Filed: Aug. 25, 2017

Related U.S. Application Data
(60) Provisional application No. 62/380,078, filed on Aug. 26, 2016.

(51) Int. Cl. B25B 13/48; F16L 55/132; E21B 33/12

(52) U.S. Cl. CPC B25B 13/481; E21B 33/12; F16L 55/132

(57) ABSTRACT

Devices for setting a plug in a pipe, as well as methods of setting a plug using such devices, are provided. Such devices may comprise an outer sheath having a longitudinal inner bore; a fitting joined to an end of the outer sheath for joining with the plug so as to prevent rotation thereof; an inner rotatable extension member extending through the inner bore of the outer sheath which is longitudinally rotatable within the inner bore; and a plug setting tool joined to an end of the inner rotatable extension member and positioned near the fitting, the plug setting tool being for engagement with the plug to cause the plug to set in the pipe when the inner rotatable extension member is rotated.

### CROSS-REFERENCE APPLICATION

The present application claims priority to U.S. provisional patent application 62/380,078 filed Aug. 26, 2016 and hereby incorporated by reference in its entirety.

### FIELD OF INVENTION

The present invention relates generally to setting plugs in pipes. More specifically, the present invention relates to devices and methods for setting a plug in pipelines and the like.

### BACKGROUND

Pipes, pipe networks, and pipelines are used extensively for transporting liquids, slurries, fluids and gases. In the energy sector, for example, pipes and pipelines are used extensively in the recovery and transport of natural resources and products refined therefrom, including oil and natural gas. Pipes and pipelines are also used extensively in water and wastewater transport, for example.

On occasion, such pipes and pipelines must be plugged to allow for maintenance or decommissioning. Plugging may be either temporary, or permanent. By way of example, temporary plugging may be desired when performing maintenance on a section of a pipeline, while permanent plugging may be desired when decommissioning a pipeline or abandoning a well.

As pipes and pipelines often traverse poorly accessible terrain and/or are buried deep beneath the ground, insertion of plugs can be quite difficult. Traditionally, sections of pipe have been exposed by excavation so as to allow access for plug insertion. These operations complicate maintenance and decommissioning operations, are both costly and time consuming, and can have a negative and harmful impact on the environment.

Furthermore, pipes and pipelines may span great distances, and often include bends and/or S-curves, which can impede insertion of a plug therein.

Alternative, additional, and/or improved tools and methods for setting a plug in a pipe is desirable.

### SUMMARY OF INVENTION

Setting a plug in a section of pipe can be difficult and/or costly, particularly where the section of pipe is difficult to access or buried deep underground. Provided herein are devices and methods for setting a plug in a pipe which allow the plug to be set remotely using a device which can optionally be subsequently withdrawn from the pipe.

In one embodiment, there is provided herein a device for setting a plug in a pipe, the device comprising:
an outer sheath having a longitudinal inner bore spanning from a first end to a second end of the outer sheath;
a fitting (optionally, a releasable fitting) located at the second end of the outer sheath and engaged therewith, the fitting for attachment (optionally, reversible attachment) with the plug so as to prevent or resist rotation of the plug in relation to the outer sheath when attached thereto;
an inner rotatable extension member having a first end and a second end, the inner rotatable extension member extending through the inner bore of the outer sheath, the inner rotatable extension member being longitudinally rotatable within the inner bore; and
a plug setting tool engaged with the second end of the inner rotatable extension member and positioned near the fitting, the plug setting tool configured for engagement with the plug, causing the plug to set in the pipe when the inner rotatable extension member is rotated within the inner bore of the outer sheath while the plug setting tool is engaged with the plug and the fitting is attached to the plug.

In another embodiment of the above device, the fitting of the device may be structured to prevent the plug setting tool from substantially withdrawing through the inner bore from the second end of the outer sheath toward the first end of the outer sheath.

In still another embodiment of any of the device or devices above, the plug may be a compression plug having a top plate and a bottom plate with a compressable plugging material therebetween, and the plug setting tool may be configured to cause the top and bottom plates to approach one another when the plug setting tool is engaged with the plug and the inner rotatable extension member is rotated while the fitting is attached to the plug, thereby compressing the compressible plugging material causing the compressible plugging material to expand outwardly to set the plug within the pipe.

In another embodiment of any of the device or devices above, the fitting of the device may be a releasable fitting, and may be configured for reversible attachment with the plug. In still further embodiments, the fitting may be configured for reversible attachment with the plug by reversibly engaging one or more corresponding attachment elements of the plug and the fitting.

In certain embodiments, the corresponding attachment elements may comprise one or more locking clips extending from the top plate of the plug (or from the fitting), the fitting being removable from the plug by withdrawing the outer sheath away from the plug while the plug is set in the pipe causing the one or more locking clips to detach. In yet another embodiment, the corresponding attachment elements may comprise one or more locking clips which may each comprise a pin with a slot formed therein, and the one or more locking clips may be accommodated through one or more corresponding holes, and the fitting may be attachable to the plug by spreading the slots while the pins are passing through the holes, and removable from the plug by pulling the device away from the plug while the plug is set in the pipe causing the slots to narrow. In still further embodiments, the corresponding attachment elements may comprise one or more pins with expanded heads and one or more corresponding keyhole slots having locking and unlocking portions, and the fitting may be attachable to the plug by inserting the pins with expanded heads into the keyhole slots through the unlocking portion and rotating the pins with expanded heads into the locking portion of the keyhole slots, and removable from the plug by rotating the pins with expanded heads back into the unlocking portion of the keyhole slots and withdrawing the pins with expanded heads out of the keyhole slots. In still further embodiments, the corresponding attachment elements may comprise one or more magnets and one or more corresponding regions of magnetically attracted material or one or more corresponding magnets, and the fitting may be attachable to the plug by engaging the magnets with the regions of magnetically attracted material or corresponding magnets, and removable from the plug by disengaging the magnets or changing the alignment of the magnets to repel. As will be understood, various configurations of the corresponding attachment elements with respect to the fitting and the plug are possible and contemplated herein.

In still another embodiment of any of the device or devices above, the inner rotatable extension member, the inner bore of the outer sheath, or both, of the device may be lubricated to facilitate rotation of the inner rotatable extension member.

In another embodiment of any of the device or devices above, the outer sheath of the device may be or comprise a plastic water pipe.

In still another embodiment of any of the device or devices above, the inner rotatable extension member of the device may be or comprise a braided cable.

In yet another embodiment of any of the device or devices above, the plug setting tool may be a socket fused to the inner rotatable extension member for engaging a nut or bolt on the plug.

In another embodiment of any of the device or devices above, the device may further comprise the plug.

In yet another embodiment, there is provided herein a use of the device or devices above for setting a plug in a pipe.

In still another embodiment, there is provided herein a method of setting a plug in a pipe using the device or devices above, said method comprising:
attaching the plug to the fitting of the device (if not already attached thereto);
inserting the plug into the pipe at a desired location along the pipe by pushing or feeding the device into the pipe until the plug has reached the desired location;
rotating the inner rotatable extension member by imparting rotational force to the inner rotatable extension member at or near its first end while preventing the outer sheath from rotating, thereby causing the plug setting tool to set the plug in the pipe; and
optionally, withdrawing the device from the pipe, causing the fitting to detach from the plug.

In another embodiment of the above method, the device may be withdrawn from the pipe causing the fitting to detach from the plug, and the method may further comprise a step of cutting the plugged pipe using a pipe cutter, such as an ultra high pressure pipe cutter.

In yet another embodiment, there is provided herein a method of temporarily setting a plug in a pipe using the device or devices above, said method comprising:
attaching the plug to the fitting of the device (if not already attached thereto);
inserting the plug into the pipe at a desired location along the pipe by pushing or feeding the device into the pipe until the plug has reached the desired location;
performing a first rotation of the inner rotatable extension member by imparting rotational force to the inner rotatable extension member at or near its first end while preventing the outer sheath from rotating, thereby causing the plug setting tool to set the plug in the pipe;
optionally, disengaging the plug from the device and subsequently re-attaching the plug to the fitting of the device;
performing a second rotation of the inner rotatable extension member by imparting rotational force to the inner rotatable extension member at or near its first end while optionally preventing the outer sheath from rotating, thereby causing the plug setting tool to unset the plug; and
withdrawing the device, attached to the plug, from the pipe, thereby removing the plug from the pipe.

In yet another embodiment of the above method, the second rotation of the inner rotatable extension member may be in a rotational direction which is opposite to that of the first rotation.

In still another embodiment, there is provided herein a device for setting a plug in a pipe, the device comprising:
an outer sheath having a longitudinal inner bore spanning from a first end to a second end of the outer sheath;
a releasable fitting located at the second end of the outer sheath and engaged therewith, the fitting for reversible attachment with the plug so as to prevent or resist rotation of the plug in relation to the outer sheath when attached thereto;
an inner rotatable extension member having a first end and a second end, the inner rotatable extension member extending through the inner bore of the outer sheath, the inner rotatable extension member being longitudinally rotatable within the inner bore; and
a plug setting tool engaged with the second end of the inner rotatable extension member and positioned near the fitting, the plug setting tool configured for engagement with the plug, causing the plug to set in the pipe when the inner rotatable extension member is rotated within the inner bore of the outer sheath while the plug setting tool is engaged with the plug and the fitting is attached to the plug.

In still another embodiment of any of the device or devices above, the device may further comprise a camera directed at the plug setting tool, providing visual information on an engagement status between the plug setting tool and the plug.

In yet another embodiment of any of the device or devices above, the device may further comprise a camera directed at the fitting, the plug, or both, providing visual information on an attachment status between the fitting and the plug.

### BRIEF DESCRIPTION OF DRAWINGS

FIG. 1 is a photograph of an embodiment of a device for setting a plug in a pipe as described herein, depicted extending from an open end of a pipeline;

FIG. 2 is a photograph of the device embodiment shown in FIG. 1, depicting the device from a second angle;

FIG. 3 is a photograph of an embodiment of a plug for plugging a pipe, which may be set in the pipe using the devices and methods described herein;

FIG. 4 is a photograph of the plug embodiment shown in FIG. 3, depicting the top side of the plug;

FIGS. 5A and 5B are photographs of the bottom (A) and top (B) faces of the top plate used in the plug embodiment shown in FIG. 3;

FIG. 6 is a photograph of the inner rotatable extension member, plug setting tool, and fitting of the embodiment of the device shown in FIG. 1, wherein the fitting is detached from the outer sheath to show the barbed fitting used to secure the fitting to the outer sheath in the embodiment of FIG. 1;

FIGS. 7A and 7B are photographs of the device embodiment of FIG. 1 having the plug embodiment of FIG. 3 attached thereto. Perspective and side profile photographs are provided in (A) and (B), respectively;

FIGS. 8A-8D are photographs showing pipeline simulations used for testing of plug setting in pipelines having 10-degree bends (A), S-bends (B), a pipeline riser (C), and another S-bend (D);

FIG. 9 is a flow diagram depicting steps of an embodiment of a method for setting a plug in a pipe using a device as described herein; and

FIGS. 10A and 10B depict a modified plug having two pins with expanded heads extending from the top plate (A) and a modified fitting having two corresponding keyhole slots with locking and unlocking portions formed therein.

### DETAILED DESCRIPTION

Described herein are devices and methods for setting a plug inside a pipe. It will be appreciated that embodiments and examples are provided herein for illustrative purposes intended for those skilled in the art, and are not meant to be limiting in any way.

In an embodiment, there is provided herein a device for setting a plug in a pipe, the device comprising:
an outer sheath having a longitudinal inner bore spanning from a first end to a second end of the outer sheath;
a fitting (optionally, a releasable fitting) located at the second end of the outer sheath and engaged therewith, the fitting configured for attachment (optionally, reversible attachment) with the plug so as to prevent or resist rotation of the plug in relation to the outer sheath when attached thereto;
an inner rotatable extension member having a first end and a second end, the inner rotatable extension member extending through the inner bore of the outer sheath, the inner rotatable extension member being longitudinally rotatable within the inner bore; and
a plug setting tool engaged with the second end of the inner rotatable extension member and positioned near the fitting, the plug setting tool configured for engagement with the plug, causing the plug to set in the pipe when the inner rotatable extension member is rotated within the inner bore of the outer sheath while the plug setting tool is engaged with the plug and the fitting is attached to the plug.

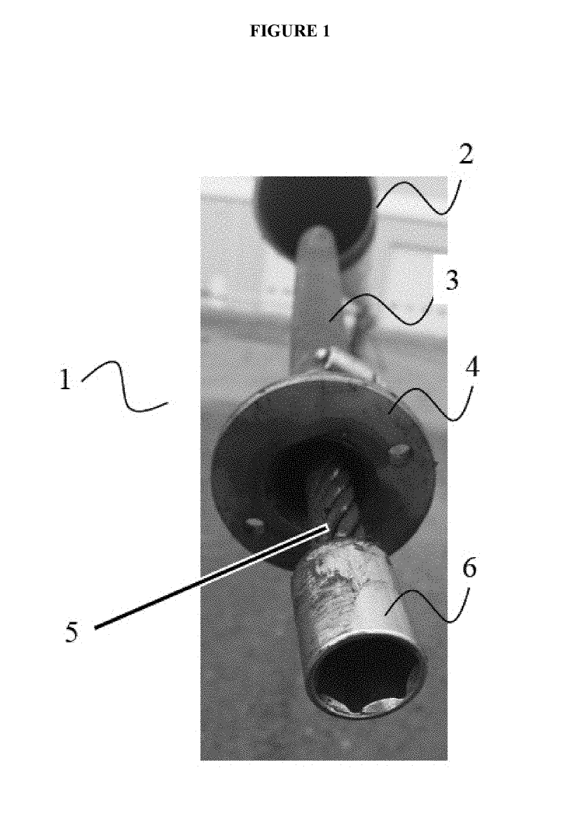

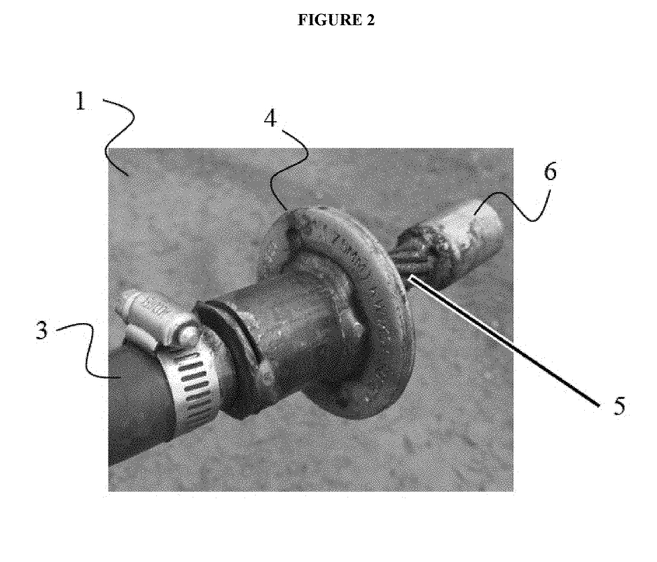

An example of such a device is depicted in FIGS. 1 and 2, where a device (1) for setting a plug in a pipe (2) is shown extending from an open end of a pipeline. The device includes an outer sheath (3) having a longitudinal inner bore spanning from a first end to a second end of the outer sheath (3), and a fitting (4) joined to the second end of the outer sheath (3), the fitting (4) being, in this example, for reversible attachment with the plug so as to prevent rotation of the plug in relation to the outer sheath when attached thereto. The device further comprises an inner rotatable extension member (5) having a first end and a second end, the inner rotatable extension member (5) extending through the inner bore of the outer sheath (3), the inner rotatable extension member (5) being longitudinally rotatable within the inner bore. As well, a plug setting tool (6) is provided, the plug setting tool (6) being attached to the second end of the inner rotatable extension member (5) and positioned near the fitting (4), the plug setting tool (6) for engagement with the plug, causing the plug to set in the pipe when the inner rotatable extension member (5) is rotated within the inner bore of the outer sheath (3) while the fitting (4) is joined to the plug.

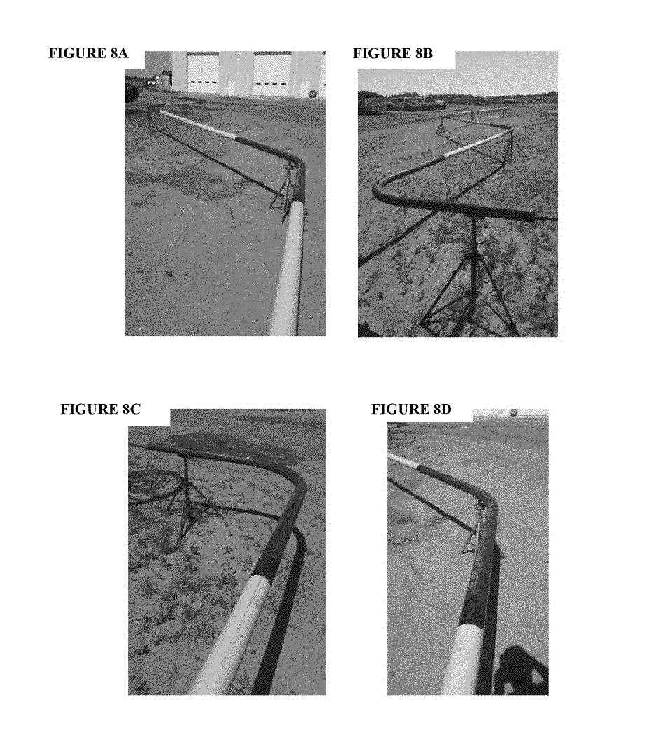

As will be understood, the pipe in which the plug is set may be any suitable pipe for which temporary or permanent plugging or capping may be desired. Pipes may include, for example, pipelines, pipe networks, production well or injection well piping, or other pipes which may be used to carry any of a variety of different liquids, slurries, fluids and/or gases which may or may not be under pressure or vacuum. By way of example, the pipe may be part of a pipeline which transports oil or natural gas. In the embodiment depicted in FIG. 1, the pipe is a pipeline commonly used in the oil and gas industry. Pipes may be linear or straight, or may include bends or curves (such as a 10-degree bend, for example, as shown in FIG. 8(A)), S-bends (for example, as shown in FIGS. 8(B) and (D)), or pipeline riser sections (for example, as shown in FIG. 8(C)), for example.

As will also be understood, the outer sheath may be any suitable outer sheath which includes a longitudinal inner bore or passage extending lengthwise along the sheath. Particularly in applications where the pipe includes bend or curve sections to be traversed, the outer sheath may be selected so as to provide sufficient flexibility to cross such bends or curves, while still maintaining sufficient structural integrity to prevent substantial kinking, to maintain the inner bore substantially intact, and to allow for pushing of the plug along the pipe when needed. As will be understood, in applications where little or no bending or curving is present (i.e. in linear or straight pipes), the outer sheath may be rigid. The person of skill in the art having regard to the teachings provided herein will be able to select a suitable outer sheath for a particular plug setting application. In the embodiment depicted in FIGS. 1 and 2, the outer sheath is a ¾ inch black plastic water line pipe, although it will be understood that many other suitable outer sheaths may be used. As will be understood, in certain embodiments the outer sheath may have cut out sections, may not enclose fully around the inner rotatable extension member, or may be configured to otherwise only partially surround the inner rotatable extension member, so long as the inner rotatable member remains rotatable within the outer sheath. Accordingly, it is contemplated that in certain embodiments the inner bore of the outer sheath may not fully surround or envelop the inner rotatable extension member extending therethrough.

As will be understood, the outer sheath may be dimensioned so as to pass within an inner bore of the pipe to be plugged, and may present an exterior surface which is sufficiently smooth or unobstructed so as to allow passage along the inner bore of the pipe without undue resistance.

The fitting of the device may include any suitable fitting which may be joined, fused, or formed with the second end of the outer sheath, and which may be joined with the plug so as to prevent rotation of the plug in relation to the outer sheath when the plug is joined thereto. Fittings may include any suitable clip, snap, buckle, pin, male-female, magnetic, friction fit, or other fitting which will be known to the person of skill in the art having regard to the teachings provided herein. The role of the fitting is to join the plug with the device, and prevent rotation of the plug relative to the outer sheath (3). These functions may be accomplished using the same element, or by different elements, comprised by the fitting. In embodiments where detachment of the device from the plug is desired, the fitting may be a releasable fitting, whereby attachment of the fitting to the device can be revsersed (i.e. detached).

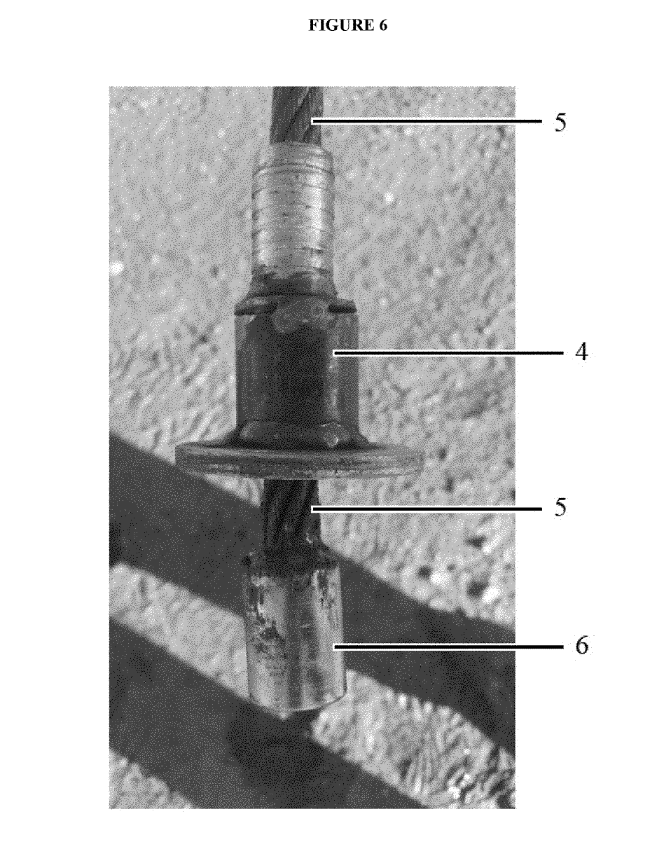

An example of a fitting, in this case a releasable fitting, is depicted in FIGS. 2 and 6. In this embodiment, the fitting (4) comprises a ¼ inch thick and 2¾ inch diameter cover plate which is fused to a 1⅜ inch pipe which is further fused to a ⅞ inch barbed fitting, and the fitting (4) is joined to the second end of the outer sheath (3) via the barbed fitting and a 1 inch hose clamp. As shown in FIGS. 1 and 2, the depicted fitting (4) includes two drilled holes for reversible engagement with a plug via locking clip pins extending from the top plate of an example of a plug, as described in further detail below.

The inner rotatable extension member of the device may be any suitable member capable of extending through the inner bore of the outer sheath, and being longitudinally rotatable within the inner bore. The inner rotatable extension member may be selected so as to provide a suitable flexibility to traverse bend or curve portions of the pipe relevant to the particular application (if any), while still maintaining suitable structural integrity to allow for the inner rotatable extension member to work the plug setting tool to set the plug. As will be understood, in applications where little or no bending or curving is present (i.e. in linear or straight pipes), the inner rotatable extension member may be rigid. By way of example, and depending on the particular application, the inner rotatable extension member may be a cable, rod, articulating or hinged or flexible rod, or other suitable member. The person of skill in the art having regard to the teachings provided herein will be able to select a suitable inner rotatable extension member for a particular plug setting application.

As will be understood, the inner rotatable extension member may be dimensioned so as to pass within the inner bore of the outer sheath, and may present an exterior surface which is sufficiently smooth or unobstructed so as to allow rotation of the inner rotatable extension member within the inner bore about a longitudinal axis thereof without undue resistance. In certain embodiments, the inner bore, the inner rotatable extension member, or both, may be lubricated or greased so as to facilitate rotation of the inner rotatable extension member without substantial strain on, or rotation of, the outer sheath.

An example of an inner rotatable extension member is depicted in FIGS. 1, 2, and 6. In this embodiment, the inner rotatable extension member (5) is a ⅝″ braided cable, although it will be recognized that many other inner rotatable extension members may be possible. In certain embodiments where a braided cable is used, the braiding of the cable may be directionally oriented such that rotation of the inner rotatable extension member (5) to work the plug setting tool when setting the plug does not cause the braiding to substantially unwind.

The plug setting tool of the device may be any suitable tool which is workable by the inner rotatable member to work on the plug, thereby setting the plug in the pipe. The plug setting tool may be selected to suit particular plug design, or a particular plugging application. The plug setting tool may be, for example, a male tool or a female tool which is capable of engaging with a complementary female or male fitting of the plug. By way of example, the plug setting tool may be a socket, bit, or hex fitting, or another suitable fitting for engaging with the plug.

An example of a plug setting tool is depicted in FIGS. 1, 2, and 6. In this embodiment, the plug setting tool (6) comprises a ¾ inch socket which is fused to the second end of the inner rotatable extension member (5).

As will be also be understood, the plug may be any suitable plug which is workable by a device as described herein to plug a pipe. Several pipe plugs are known in the art which may be suitable for direct use, or which may be adaptable for use, with a device or method as described herein. In certain embodiments, the plug may be, for example, a compression plug, although other plugs may be possible and may be selectable by the person of skill in the art having regard to the teachings herein to suit a particular application. The skilled person will be aware of applicable governing regulatory board standards, if any, and will be able to select a suitable plug for a particular application accordingly.

In certain embodiments of a device as described herein, the fitting may be structured so as to prevent the plug setting tool from substantially withdrawing through the inner bore from the second end of the outer sheath toward the first end of the outer sheath. By way of example, the releasable fitting (4) depicted in FIGS. 1, 2, and 6 includes a 1⅜ inch pipe section which prevents the plug setting tool (6) (in this example, a ¾ inch socket) from withdrawing through the inner bore. The skilled person will understand that other designs for preventing the plug setting tool from substantially withdrawing through the inner bore may also be possible.

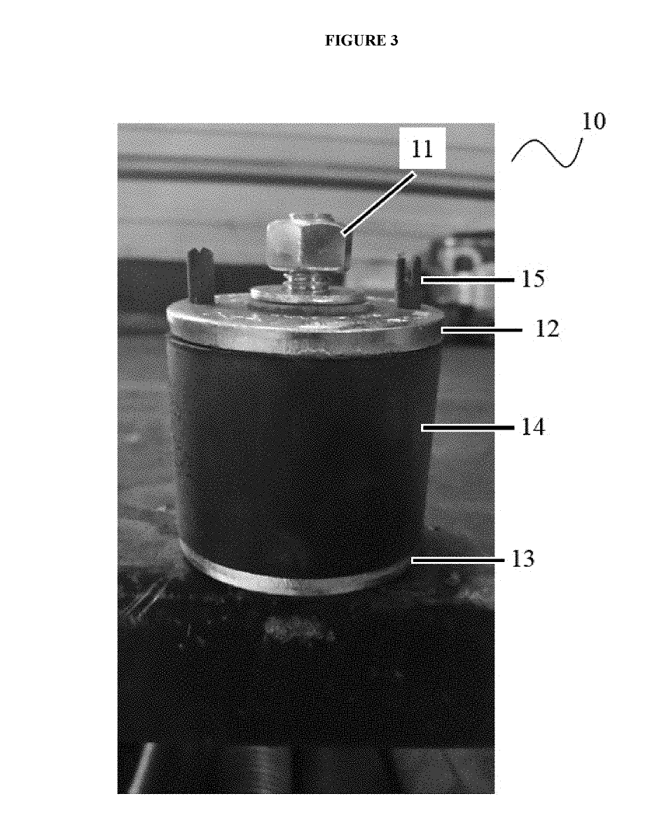

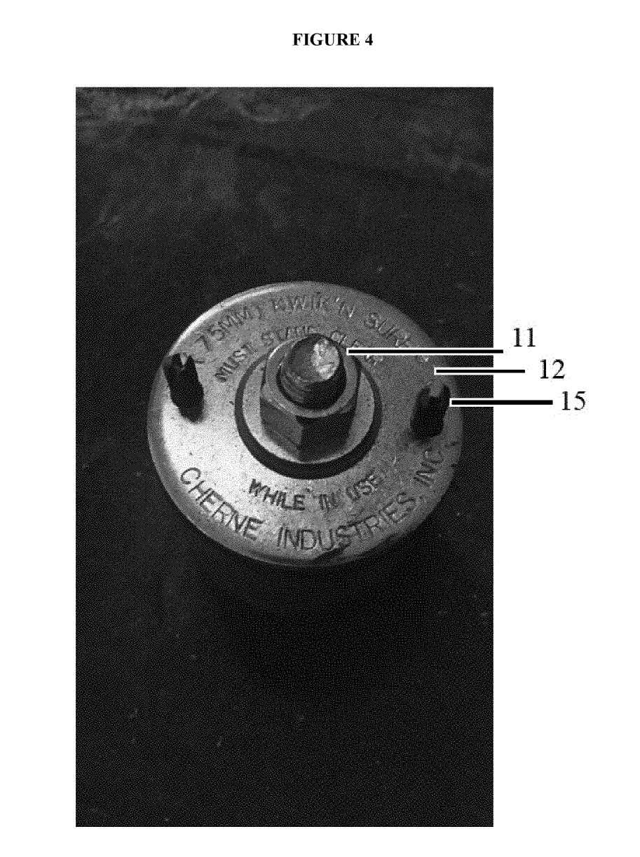

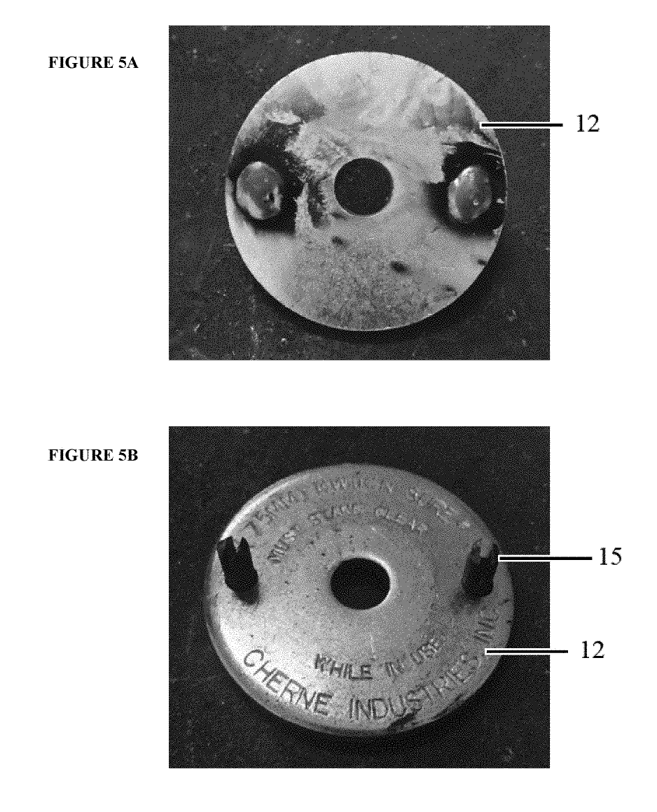

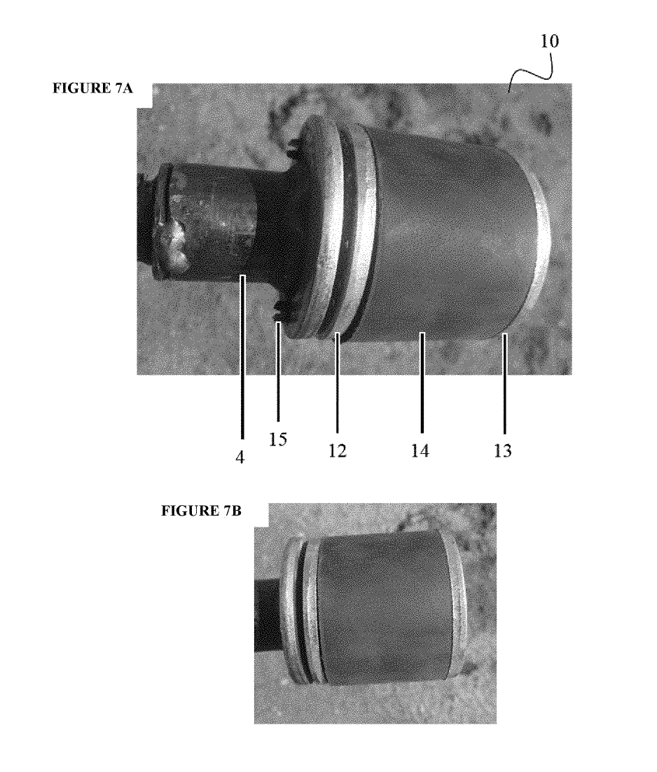

An example of a plug is depicted in FIGS. 3, 4, 5, and 7. In this embodiment, the plug (10) is a compression plug (in this example, a 3 inch compression plug) having a top plate (12) and a bottom plate (13) with a compressable plugging material (14) (in this example, rubber) therebetween, and a bolt/nut (11) (in this case, a locking nut is depicted) spanning between the top (12) and bottom (13) plates. In this embodiment, the plug setting tool (6) causes the top (12) and bottom (13) plates to approach one another when the plug setting tool (6) is engaged with the bolt/nut (11) of the plug (10) and the inner rotatable extension member (5) is rotated while the releasable fitting (4) is joined to the plug (10), thereby causing the nut to force the top (12) and bottom (13) plates together, causing the compressible plugging material (14) to expand radially outwardly to set the plug (10) within the pipe. In this illustrative and non-limiting example, approximately 25-30 turns of the inner rotatable extension member were sufficient to set the plug in the pipe.

In the plug embodiment depicted in FIGS. 3, 4, 5, and 7, the fitting (4) of the device embodiment reversibly joins with the plug (10) by accommodating one or more locking clips (15) extending from the top plate (12) of the plug (10). The exemplified fitting (4) is removable from the plug (10) by withdrawing the outer sheath (3) to which the fitting (4) is joined away from the plug (10) while the plug (10) is set in the pipe, which causes the one or more locking clips (15) to detach from the fitting (4).

In the embodiment depicted in FIGS. 3, 4, 5, and 7, the one or more locking clips (15) each comprise a ¼ inch pin or rod with a slot formed therein, and the one or more locking clips (15) are accommodated by the fitting (4) through one or more holes formed therein. The fitting (4) is attachable to the plug (10) by spreading the slots while the pins are passing through the holes, and removable from the plug (10) by pulling the device (1) away from the plug (10) while the plug (10) is set in the pipe which causes the slots to narrow allowing the locking clips (15) to exit the holes in the fitting (4).

As will be understood, the skilled person having regard to the teachings provided herein will be aware of several different configurations suitable for attaching the fitting to the plug. By way of example, where a reversible attachment is desired, the fitting of the device may be a releasable fitting, and may be configured for reversible attachment with the plug by reversibly engaging one or more corresponding attachment elements of the plug and the fitting. In certain embodiments, the corresponding attachment elements may comprise one or more locking clips extending from the top plate of the plug (or from the fitting), the fitting being removable from the plug by withdrawing the outer sheath away from the plug while the plug is set in the pipe causing the one or more locking clips to detach. In yet other embodiments, the corresponding attachment elements may comprise one or more locking clips which may each comprise a pin with a slot formed therein, and the one or more locking clips may be accommodated through one or more corresponding holes, and the fitting may be attachable to the plug by spreading the slots while the pins are passing through the holes, and removable from the plug by pulling the device away from the plug while the plug is set in the pipe causing the slots to narrow. In still further embodiments, the corresponding attachment elements may comprise one or more magnets and one or more corresponding regions of magnetically attracted material or one or more corresponding magnets, and the fitting may be attachable to the plug by engaging the magnets with the regions of magnetically attracted material or corresponding magnets, and removable from the plug by disengaging the magnets or changing the alignment of the magnets to repel. In still further embodiments, the corresponding attachment elements may comprise one or more pins with expanded heads and one or more corresponding keyhole slots having locking and unlocking portions, and the fitting may be attachable to the plug by inserting the pins with expanded heads into the keyhole slots through the unlocking portion and rotating the pins with expanded heads into the locking portion of the keyhole slots, and removable from the plug by rotating the pins with expanded heads back into the unlocking portion of the keyhole slots and withdrawing the pins with expanded heads out of the keyhole slots.

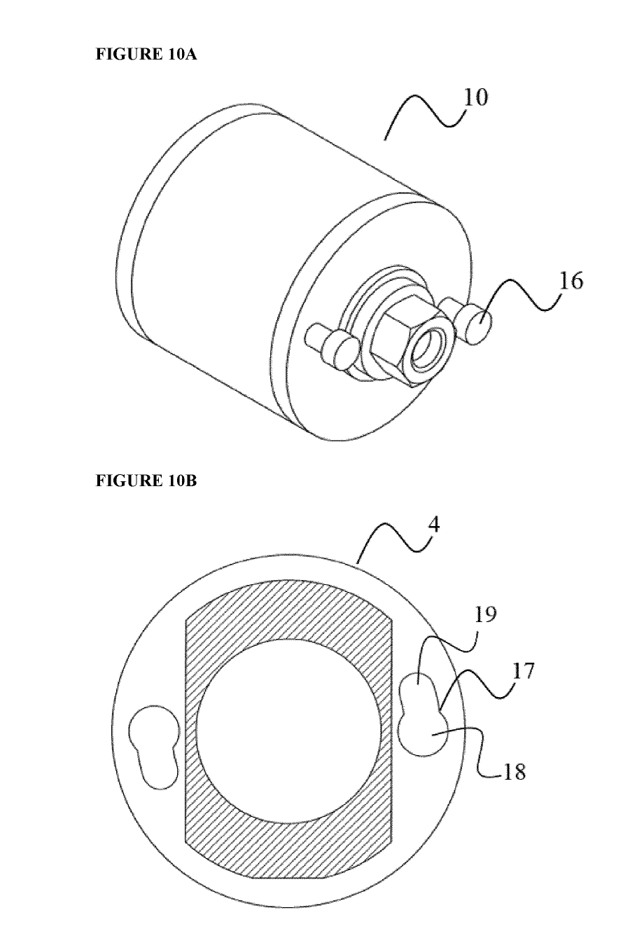

FIGS. 10A and 10B depict an embodiment of a plug (10) and fitting (4) employing an example of the above-described reversible attachment via corresponding attachment elements. In this case, the plug (10) comprises two pins with expanded heads (16), and the fitting (4) comprises two corresponding keyhole slots (17) each having an unlocking portion (18) and a locking portion (19). The depicted fitting (4) is attachable to the plug (10) by inserting the pins with expanded heads (16) into the keyhole slots (17) through the unlocking portion (18) and rotating the pins with expanded heads (16) into the locking portion (19) of the keyhole slots (17), and removable from the plug (10) by rotating the pins with expanded heads (16) back into the unlocking portion (18) of the keyhole slots (17) and withdrawing the pins with expanded heads (16) out of the keyhole slots (17).

As will be understood, various configurations of the corresponding attachment elements with respect to the fitting and the plug are possible and contemplated herein.

The person of skill in the art having regard to the teachings herein will understand that various compatible plug/fitting designs may be possible, and selectable based on the particular plugging application.

For the device embodiment depicted in FIGS. 1-7, the device was used in testing to push the plug through a pipeline starting at a riser, through a 10-degree bend, and through up to 2 S-bends, and out to a lease edge where the plug was set in place and the device was separated from the set plug and withdrawn from the pipeline. Testing also used the exemplified device to set the plug at a distance of 200′ to 400′ along a pipeline by pushing the device into the pipeline by hand.

The devices described hereinabove allow for the device to be separated from the plug once the plug has been set, and for the device to be withdrawn from the pipe. This may be desirable in many different applications, including both maintenance and decommissioning applications.

It will be understood that, in certain embodiments, it may be desirable that the plug remain joined to the device, without becoming separated therefrom. For example, in applications where temporary plugging is needed, it may be desirable to maintain attachment so as to allow for the plug to be inserted into the pipe and set by the device, and then subsequently unset and withdrawn from the pipe by the device without the device becoming detached therefrom.

As such, in certain embodiments, the fitting of the device may include a fitting which does not release, or which is fused, joined, or attached, with the plug. Thus, in certain embodiments, the releasable nature of the fitting may be optional. By way of example, replacing the locking clips (15) in FIG. 3 with bolts, and securing the plug (10) to the fitting (4) using nuts tightened along these bolts, would provide a device which remains secured to the plug during use, and which would allow plug insertion, setting, unsetting, and removal from a pipe without occurrence of detachment of the plug from the device.

As will be understood, in certain embodiments it may be desirable that pipe plugging be accompanied by pipe cutting. By way of example, decommissioning or abandonment of a plugged oil or gas well typically involves cutting and removal of wellbore casings to a depth of two meters below the surface. As such, in certain embodiments, it is contemplated that methods and devices as described herein may be used in combination with ultra high pressure pipe cutters such as those described in U.S. Pat. No. 8,820,396, which is herein incorporated by reference in its entirety.

In yet another embodiment, there is provided herein a method of setting a plug in a pipe using a device as described hereinabove, said method comprising:
attaching the plug to the fitting of the device (if not already attached thereto);
inserting the plug into the pipe at a desired location along the pipe by pushing or lowering or feeding the device into the pipe until the plug has reached the desired location;
rotating the inner rotatable extension member by imparting rotational force to the inner rotatable extension member at or near its first end while preventing the outer sheath from rotating, thereby causing the plug setting tool to set the plug in the pipe; and
optionally, withdrawing the device from the pipe, causing the fitting to detach from the plug.

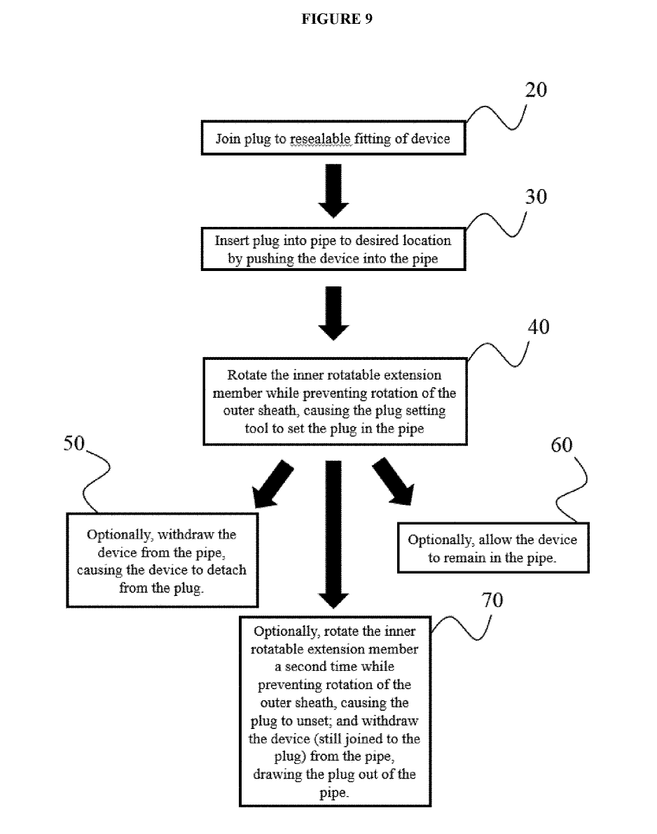

A flow diagram depicting steps of an embodiment of a method for setting a plug in a pipe as described herein is provided in FIG. 9. In this illustrative embodiment, the method may include a step (20) of joining a plug to a device as described hereinabove. As will be understood, this step need not be performed if the plug is already joined with the device. The illustrative method of FIG. 9 further includes a step (30) of inserting the plug into the pipe to be plugged by pushing the device into the pipe. As will be understood, in step (30) the force of feeding or pushing the device into the pipe (and/or the force of gravity, in the case of vertical pipe sections) will cause the plug to travel through the pipe. This action may be continued until the plug has reached a desired location along the pipe at which the plug is to be set. Distance traveled by the plug into the pipe, and the location of the plug within the pipe, can be determined by tracking the length of the device which has been fed into the pipe, and/or by other suitable pipe sensing methods known in the art which would allow the location of the plug within the pipe to be determined (such as, for example, radio signalling, sonic detection methods, or other suitable methods).

Once the plug has reached the desired pipe location in step (30), the plug can be set in the pipe by performing step (40) involving rotating the inner rotatable extension member of the device, thereby causing the plug setting tool to work on the plug so as to set the plug. During illustrated step (40), rotation of the outer sheath of the device is substantially prevented or resisted, thereby substantially preventing rotation of the plug in the pipe so as to facilitate setting of the plug.

Once the plug has been set in the pipe in step (40), an optional step (50) may be performed wherein the device may be withdrawn or pulled from the pipe, causing the device to detach from the plug and allow the device to be withdrawn from the pipe and, optionally, reused for setting another plug in the same or another pipe, or for retrieving the set plug or another set plug. As will be understood, performance of step (50) may be desirable depending on the particular plugging application. If the plug is to remain permanently in the pipe, for example, then performing this step may be desirable so as to allow the device to be recovered and reused.

An alternative optional step (60) is also contemplated herein, wherein the device may remain attached to the plug and remain in the pipe, or may be detached from the plug and remain in the pipe, as desired depending on the particular application.

Another alternative optional step (70) is also contemplated herein, wherein the inner rotatable extension member may be rotated a second time (in this example, rotation may be in a direction opposite the rotation of step (40)), thereby causing the plug setting tool to work on the plug so as to unset the plug. During illustrated step (70), rotation of the outer sheath of the device may be substantially prevented, thereby preventing rotation of the plug in the pipe as it begins to unset. It will be understood that the set plug may already be resistant to rotating in the pipe, and so preventing rotation of the outer sheath may unnecessary in certain examples. Once the plug has been unset, optional step (70) may further include moving the plug to a new location in the pipe by inserting or withdrawing the device (which is still joined to the plug) and then setting the plug again in the new location, and/or may include withdrawing the device, which is still joined to the plug, from the pipe, thereby removing the plug from the pipe.

As will be understood, the device may optionally be detached from the plug and then subsequently re-attached to the plug between the first rotation and second rotation steps. Such an optional step may be desirable where, for example, a maintenance operation is to be performed after the plug is set which is more easily accomplished with the device removed from the pipe. In such embodiments, a corresponding attachment element configuration between the fitting and the plug, as described hereinabove, may be used for the optional detachment and subsequent re-attachment steps. For example, the pin with expanded head/keyhole configuration illustrated in FIG. 10 may allow for such detachment and re-attachment.

In still further embodiments, it is contemplated that the device may further comprise a camera directed at the plug setting tool, providing visual information on an engagement status between the plug setting tool and the plug. In yet another embodiment, it is contemplated that the device may further comprise a camera directed at the fitting, the plug, or both, providing visual information on an attachment status between the fitting and the plug. Such camera(s) may facilitate the optional detachment/re-attachment step described above, and/or may facilitate retrieval of another plug set in a pipe, by providing a user with information allowing the user to more easily align the fitting and/or plug setting tool with the set plug during re-attachment.

As will by understood, performance of step (70) may be desirable depending on the particular plugging application. If the plug is to be set in a number of different locations as part of an operation, for example a maintenance operation, then performing step (70) may be desirable. As well, if the plug is to be set in the pipe temporarily (so as to allow a maintenance or other operation to be performed on the pipe, for example) and then withdrawn from the pipe, for example, then performing this step may be desirable so as to allow the device and plug to be recovered and, optionally, reused.

One or more illustrative embodiments have been described by way of example. It will be understood to persons skilled in the art that a number of variations and modifications can be made without departing from the scope of the invention as defined in the claims.

What is claimed is:

1. A device for setting a plug in a pipe, the device comprising:
an outer sheath having a longitudinal inner bore spanning from a first end to a second end of the outer sheath;
a fitting located at the second end of the outer sheath and engaged therewith, the fitting for attachment with the plug so as to prevent or resist rotation of the plug in relation to the outer sheath when attached thereto;
an inner rotatable extension member having a first end and a second end, the inner rotatable extension member extending through the inner bore of the outer sheath, the inner rotatable extension member being longitudinally rotatable within the inner bore; and
a plug setting tool engaged with the second end of the inner rotatable extension member and positioned near the fitting, the plug setting tool configured for engagement with the plug, causing the plug to set in the pipe when the inner rotatable extension member is rotated within the inner bore of the outer sheath while the plug setting tool is engaged with the plug and the fitting is attached to the plug.

2. The device according to claim 1, wherein the fitting is structured to prevent the plug setting tool from substantially withdrawing through the inner bore from the second end of the outer sheath toward the first end of the outer sheath.

3. The device according to claim 1, wherein the plug is a compression plug having a top plate and a bottom plate with a compressable plugging material therebetween, and the plug setting tool is configured to cause the top and bottom plates to approach one another when the plug setting tool is engaged with the plug and the inner rotatable extension member is rotated while the fitting is attached to the plug, thereby compressing the compressible plugging material causing the compressible plugging material to expand outwardly to set the plug within the pipe.

4. The device according to claim 1, wherein the fitting is a releasable fitting configured for reversible attachment with the plug by reversibly engaging one or more corresponding attachment elements of the plug and the fitting.

5. The device according to claim 4, wherein the corresponding attachment elements comprise one or more locking clips; pins with slots formed therein and corresponding holes; pins with expanded heads and corresponding keyhole slots; magnets and corresponding regions of magnetically attracted material or corresponding magnets; or any combination thereof.

6. The device according to claim 4, wherein the fitting is configured for reversible attachment with the plug by reversibly engaging one or more locking clips extending from the top plate of the plug, the fitting, or both, and the fitting being removable from the plug by withdrawing the outer sheath away from the plug while the plug is set in the pipe causing the one or more locking clips to detach.

7. The device according to claim 6, wherein the one or more locking clips comprise a pin with a slot formed therein, and the one or more locking clips are engagable through one or more corresponding holes, and wherein the fitting is attachable to the plug by spreading the slots while the pins are passing through the holes, and removable from the plug by pulling the device away from the plug while the plug is set in the pipe causing the slots to narrow.

8. The device according to claim 4, wherein the corresponding attachment elements comprise one or more pins with expanded heads and corresponding keyhole slots having locking and unlocking portions, and wherein the fitting is attachable to the plug by inserting the pins with expanded heads into the keyhole slots through the unlocking portions and rotating the pins with expanded heads into the locking portions of the keyhole slots, and removable from the plug by rotating the pins with expanded heads back into the unlocking portions of the keyhole slots and withdrawing the pins with expanded heads out of the keyhole slots.

9. The device according to claim 4, wherein the corresponding attachment elements comprise one or more magnets and corresponding regions of magnetically attracted material or corresponding magnets, and wherein the fitting is attachable to the plug by engaging the magnets with the regions of magnetically attracted material or corresponding magnets, and removable from the plug by disengaging the magnets or changing the alignment of the magnets to repel the corresponding magnets.

10. The device according to claim 1, wherein the inner rotatable extension member, the inner bore of the outer sheath, or both, are lubricated to facilitate rotation of the inner rotatable extension member.

11. The device according to claim 1, wherein the outer sheath is a plastic water pipe.

12. The device according to claim 1, wherein the inner rotatable extension member is a braided cable.

13. The device according to claim 1, wherein the plug setting tool is a socket fused to the inner rotatable extension member for engaging a nut or bolt on the plug.

14. The device according to claim 1, wherein the device further comprises a camera directed at the plug setting tool providing visual information on an engagement status between the plug setting tool and the plug; a camera directed at the fitting, the plug, or both, providing visual information on an attachment status between the fitting and the plug; or both.

15. The device according claim 1, further comprising the plug.

16. Use of the device according to claim 1 for setting a plug in a pipe.

17. A method of setting a plug in a pipe using a device as defined in claim 1, said method comprising:
attaching the plug to the fitting of the device;
inserting the plug into the pipe at a desired location along the pipe by pushing or feeding the device into the pipe until the plug has reached the desired location;
rotating the inner rotatable extension member by imparting rotational force to the inner rotatable extension member at or near its first end while preventing the outer sheath from rotating, thereby causing the plug setting tool to set the plug in the pipe; and
optionally, withdrawing the device from the pipe, causing the fitting to detach from the plug.

18. The method of claim 17, wherein the device is withdrawn from the pipe causing the fitting to detach from the plug, and further comprising a step of cutting the plugged pipe using a pipe cutter.

19. A method of temporarily setting a plug in a pipe using a device as defined in claim 1, said method comprising:
attaching the plug to the fitting of the device;
inserting the plug into the pipe at a desired location along the pipe by pushing or feeding the device into the pipe until the plug has reached the desired location;
performing a first rotation of the inner rotatable extension member by imparting rotational force to the inner rotatable extension member at or near its first end while preventing the outer sheath from rotating, thereby causing the plug setting tool to set the plug in the pipe;
optionally, disengaging the plug from the device and subsequently re-attaching the plug to the fitting of the device;
performing a second rotation of the inner rotatable extension member by imparting rotational force to the inner rotatable extension member at or near its first end while optionally preventing the outer sheath from rotating, thereby causing the plug setting tool to unset the plug; and
withdrawing the device, attached to the plug, from the pipe, thereby removing the plug from the pipe.

20. The method of claim 19, wherein the second rotation of the inner rotatable extension member is in a rotational direction which is opposite to that of the first rotation.
